(19) United States
(12) Patent Application Publication
(10) Pub. No.: US 2002/0009599 A1
(43) Pub. Date: Jan. 24, 2002

(54) Photochromic polyurethane coating and articles having such a coating

(76) Inventors: Cletus N. Welch, Murrysville, PA (US); Jessica A. Hoch, Tampa, FL (US); Jeanine A. Conklin, Swissvale, PA (US); Shanti Swarup, Allison Park, PA (US)

Correspondence Address: PPG INDUSTRIES INC, INTELLECTUAL PROPERTY DEPT, ONE PPG PLACE, PITTSBURGH, PA, 15272, US

(21) Appl. No.: 09/755,147

(22) Filed: Jan. 8, 2001

Related U.S. Application Data
(60) Provisional application No. 60/178,095, filed on Jan. 26, 2000.

(51) Int. Cl. B32B 27/00; B32B 27/40

(52) U.S. Cl. 428/423.1; 428/425.5

(57) ABSTRACT

Described are photochromic polyurethane coatings having improved durability as demonstrated by reduced swelling upon exposure to alcoholic solvents in the Percent Swelling Test. The coatings are prepared using polycarbonate polyols alone or in combination with different polyols as the source of hydroxyl groups. Also described are articles having such coatings. The coatings exhibit a Fischer microhardness of from 50 to 150 Newtons per mm² and good photochromic properties.

### CROSS REFERENCE TO RELATED APPLICATIONS

This application claims priority to provisional application Serial No. 60/178,095, filed Jan. 26, 2000.

### DESCRIPTION OF THE INVENTION

The present invention relates to photochromic polyurethane coatings having improved durability. More particularly, this invention relates to articles having certain photochromic polyurethane coatings that are more durable, i.e., more resistant to the formation of cosmetic defects related to scratches during the use of the coated article, than commercially known photochromic polyurethane coatings. Furthermore, this invention relates to photochromic polyurethane coatings that meet commercially acceptable “cosmetic” standards for optical coatings applied to optical elements, e.g., lenses.

Photochromic compounds exhibit a reversible change in color when exposed to light radiation involving ultraviolet rays, such as the ultraviolet radiation in sunlight or the light of a mercury lamp. Various classes of photochromic compounds have been synthesized and suggested for use in applications in which a sunlight-induced reversible color change or darkening is desired. The most widely described classes of photochromic compounds are oxazines, pyrans and fulgides.

The use of photochromic compounds in polyurethanes has been disclosed. WO 98/37115 describes photochromic polyurethane coatings that exhibit a Fischer microhardness of from 50 to 150 Newtons per mm² and improved photochromic properties. German Democratic Republic Patent No. 116 520 describes a method of preparing photochromic polymer systems which include photochromic ortho-nitrobenzyl compounds added to reaction systems which lead to polyurethanes. European Patent Application Number 0 146 136 describes an optical element with a photochromic coating, such as a polyurethane lacquer in which are incorporated one or more phototropic substances. U.S. Pat. No. 4,889,413 describes a process for producing a polyurethane plastic having photochromic properties. Japanese Patent Application 3-269507 describes a light adjusting plastic lens composed of a plastic base material, a primer layer consisting of a thermosetting polyurethane containing a photochromic substance placed over the base material and a silicone resin hardcoat layer covering the polyurethane layer. Japanese Patent Application 5-28753 describes a coating material with photochromic properties containing urethane products for formation of the coating matrix and organic photochromic compounds. European Patent Application 0 927 730 describes a photochromic polyurethane comprising (a) polyols of which from 20 to 60 weight percent have a molecular weight of 500 to 6000 grams per mole (g/mole) and from 5 to 35 weight percent have a molecular weight of from 62 to 499 g/mole, (b) aliphatic polyisocyanates and (c) photochromic compound.

Articles, e.g., lenses, having a photochromic polyurethane layer coated with a protective hardcoat have been found to exhibit cosmetic defects after regular use. The defects are associated with scratches that penetrate the hardcoat. The opening through the hardcoat allows the migration of liquids, e.g., cleaning agents, into the polyurethane layer. The liquids, such as alcoholic solvents, cause the polyurethane layer to swell. Typically, the amount of swelling is 25% or more as measured in the Percent Swelling Test described herein. The resulting effect is a cosmetic defect that has the appearance of an exaggerated scratch in the lens.

Although the use of photochromic compounds in polyurethanes has been described in the literature, there is still a need for improved photochromic polyurethane coated articles. Such articles should have coating thicknesses necessary to demonstrate good photochromic properties, i.e., color and fade at acceptable rates, and achieve a dark enough colored state. Further, the articles should be resistant to defects caused by scratches through a protective hardcoat that cause swelling of the photochromic polyurethane coating upon exposure to cleaning agents, e.g., alcoholic solvents.

A photochromic polyurethane coating that has acceptable Fischer microhardness, good photochromic properties and improved resistance to scratch related defects has now been discovered. The coating is prepared by combining polycarbonate polyol(s) having a molecular weight of from 500 to 5,000 grams per mole, optionally, a different polyol having a molecular weight of at least 500 grams per mole, an isocyanate, photochromic compound(s) and optional catalyst in such proportions to produce a photochromic polyurethane coating exhibiting less than 25% swell in the Percent Swelling Test. This coating also exhibits a Fischer microhardness of from 50 to 150 Newtons per mm².

### DETAILED DESCRIPTION OF THE INVENTION

Other than in the operating examples, or where otherwise indicated, all values, such as those expressing wavelengths, quantities of ingredients, ranges or reaction conditions, used in this description and the accompanying claims are to be understood as modified in all instances by the term “about”.

The disclosures of the patents and articles cited herein describing procedures for making the polycarbonate polyols, modifying isocyanates, producing polyiso(thio)cyanates, catalysts, photochromic compounds and stabilizing compositions and identifying cosmetic defects are incorporated herein, in toto, by reference.

Polyurethanes that may be used to prepare photochromic polyurethane coatings of the present invention are those produced by the catalyzed or uncatalyzed reaction of a composition comprising polycarbonate polyol(s) having a molecular weight (derived from the Hydroxyl Number) of from 500 to 5,000 grams per mole and optionally, a different organic polyol, provided that the molecular weight of the different organic polyol is at least 500 grams per mole, and an isocyanate component. Optionally, a catalyst may be present in the composition. When the components are combined to produce a polyurethane composition that is applied as a coating and cured, the coating exhibits a Fischer microhardness in the range of from 50 to 150 Newtons per mm², acceptable photochromic performance properties and less than 25 percent swell in the Percent Swelling Test described in Part D of Example 15 herein.

The Fischer microhardness of the cured coating compositions of the present invention are at least 50 Newtons per mm², preferably at least 60, more preferably, at least 70 Newtons per mm² and not more than 150 Newtons per mm², preferably, not more than 145 and more preferably not more than 135 Newtons per mm². The Fischer microhardness of the coating may range between any combination of these values, inclusive of the recited values, e.g., from 51 to 149 Newtons per mm².

The photochromic performance properties contemplated herein are a ΔOD of at least 0.15 after 30 seconds and at least 0.28 after 8 minutes, and a Bleach rate of less than 70 seconds—all as measured in the 85° F. (29° C.) Photochromic Performance Test defined in Part E of Example 15 herein.

In the photochromic polyurethane coatings of the present invention, the amount of polycarbonate polyol(s), i.e., diols, triols, etc., used to prepare the coating is an amount that results in the cured polyurethane coating having a percent swell less than 25%, preferably, 20% or less, more preferably, 15% or less, and most preferably, 10% or less in the Percent Swelling Test described herein. Such an amount of polycarbonate polyol may be considered to be a swell reducing amount. Typically, the swell reducing amount of polycarbonate polyol in the organic polyol component of the polyurethane coating ranges from 10 to 100 percent of the hydroxyl equivalents, based on the total number of hydroxyl equivalents provided by the polyol component. Preferably, this amount ranges from 20 to 80 percent hydroxyl equivalents, more preferably, from 20 to 70 and most preferably, from 20 to 60 percent of the hydroxyl equivalents. The swell reducing amount of polycarbonate polyol may range between any combination of these values, inclusive of the recited values, e.g., from 15 to 85 percent, of the total number of hydroxyl equivalent.

Polycarbonate diols, i.e., polyols, that may be used in the polyurethane coatings described herein may be represented by either of the following general formula or a mixture of the polyols represented by the two formulae:

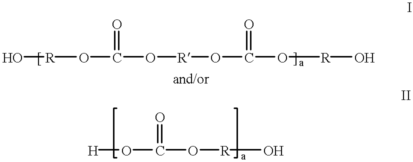

wherein R and R′ may be the same or different and represent divalent linear, branched or cyclic C₂-C₁₀ aliphatic radicals or divalent C₆-C₁₅ aromatic radicals, e.g. 2,2-diphenylenepropane, and a is an integer selected from 3 to 15, provided that the molecular weight of the polycarbonate is from 500 to 5000 grams per mole. The Molecular Weight is determined by multiplying 56,100 by the number of OH groups per molecule and dividing the result by the hydroxyl number. The hydroxyl number is determined according to ASTME-1899-97 Standard Test Method for Hydroxyl Groups Using Reactions with p-Toluenesulfonyl Isocyanate (TSI) and Potentiometric Titration with Tetrabutylammonium hydroxide.

The polycarbonate polyols of general formula I may be formed by the reaction of a bis(chloroformate) with a polyol, e.g., a diol, as described in U.S. Pat. No. 5,266,551. One of the components can be used in excess to limit and control the molecular weight of the resulting polycarbonate polyol. As shown in the following Polycarbonate Preparation Scheme, the diol is in excess and becomes the end group. Alternatively, the bis(chloroformate) could be in excess to give a chloroformate-terminated oligomer which is then hydrolyzed to form a hydroxyl end group. Therefore, polyols can be prepared from these components with either R or R′ in excess.

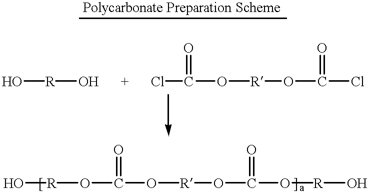

Examples of bis(chloroformates) which can be used in the aforedescribed preparation scheme include monoethylene glycol bis(chloroformate), diethylene glycol bis(chloroformate), butanediol bis(chloroformate), hexanediol bis(chloroformate), neopentyldiol bis(chloroformate), bisphenol A bis(chloroformate) or mixtures of such bischloroformates.

Examples of polyols which can be used in the aforedescribed preparation scheme include bisphenol A; trimethylolethane; trimethylolpropane; di-(trimethylolpropane)dimethylol propionic acid; ethylene glycol; propylene glycol; 1,3-propanediol; 2,2-dimethyl-1,3-propanediol; 1,2-butanediol; 1,4-butanediol; 1,3-butanediol; 1,5-pentanediol; 2,4-pentanediol; 2,2,4-trimethyl-1,3-pentanediol; 2-methyl-1,3-pentanediol; 2-methyl-1,5-pentanediol; 3-methyl-1,5-pentanediol; 1,6-hexanediol; 2,5-hexanediol; 2-ethyl-1,3-hexanediol; 1,4-cyclohexanediol; 1,7-heptanediol; 2,4-heptanediol; 1,8-octanediol; 1,9-nonanediol; 1,10-decanediol;; 2,2-dimethyl-3-hydroxypropyl-2,2-dimethyl-3-hydroxypropionate; diethylene glycol; triethylene glycol; tetraethylene glycol; polyethylene glycol having a molecular weight of from 200 to 600 grams per mole; dipropylene glycol; tripropylene glycol; polypropylene glycol having a molecular weight of from 200 to 600 grams per mole; 1,4-cyclohexanedimethanol; 1,2-bis(hydroxymethyl)cyclohexane; 1,2-bis(hydroxyethyl)cyclohexane; the alkoxylation product of 1 mole of 2,2-bis(4-hydroxyphenyl)propane (i.e., bisphenol-A) and from 2 to 10 moles of ethylene oxide and/or propylene oxide; poly(oxytetramethylene)diols having a number average molecular weight of less than 500, e.g., 250; polycaprolactone polyols having a molecular weight of from 250 to 800 grams per mole and mixtures of such polyols.

The above components may be combined to form a variety of compositions, chain lengths and end groups for a polycarbonate polyol having a molecular weight from 500 to 5000 grams per mole.

In one contemplated embodiment, the polycarbonate polyols have a molecular weight from 1000 to 4000. In another contemplated embodiment, the polycarbonate polyols have molecular weight of from 1500 to 3000. The molecular weight of the polycarbonate polyols may range between any combination of these values, inclusive of the recited range, e.g., from 501 to 4999 grams per mole. The polyols can have terminal aliphatic hydroxyl groups (e.g., diethylene glycol groups), phenolic terminal groups (e.g., bisphenol A groups) or a mixture of such terminal hydroxyl groups.

The polycarbonate polyols of general formula II may be prepared by an ester interchange reaction of a dialkyl, diaryl or alkylene carbonate with a polyol, as described in U.S. Pat. Nos. 4,131,731, 4,160,853, 4,891,421 and 5,143,997. Other examples of polycarbonate polyols include materials prepared: by the reaction of a polyol and phosgene, as described in U.S. Pat. No. 4,533,729; and by the reaction of a polycarbonate polyol with an acid anhydride or a dicarboxylic acid, as described in U.S. Pat. No. 5,527,879. Further examples of polycarbonate polyols include poly(meth)acrylates with grafted-on polycarbonate chains, such as those described in U.S. Pat. No. 5,140,066. Examples of commercially available products include RAVECARB® 102-108 series of polycarbonate diols available from EniChem Synthesis Milano and PC 1122 available from Stahl USA.

The photochromic polyurethane composition of the present invention may contain one polycarbonate polyol or a mixture of polycarbonate polyols, as desired.

The polyurethane formulations of the present invention contain an equivalent ratio of NCO:OH ranging between 0.3:1.0 and 3.0:1.0. In one contemplated embodiment, the equivalent ratio of NCO:OH of the photochromic polyurethane coatings of the present invention ranges between 0.9:1.0 and 2.0:1.0, in another, between 1.0:1.0 and 1.8:1.0, and in a further contemplated embodiment, between 1.1:1.0 and 1.7:1.0, e.g., 1.6:1.0. The equivalent ratio of NCO:OH may range between any combination of these ranges, inclusive of the recited ratios.

The isocyanate component of the present invention, as used herein, includes “modified”, “unmodified” and mixtures of the “modified” and “unmodified” isocyanate compounds having “free”, “blocked” or partially blocked isocyanate groups. The isocyanate may be selected from the group consisting of aliphatic, aromatic, cycloaliphatic and heterocyclic isocyanates, and mixtures of such isocyanates. The term “modified” means that the aforementioned isocyanates are changed in a known manner to produce adducts and to introduce biuret, urea, carbodiimide, urethane or isocyanurate groups. An example of an adduct is the reaction product of one mole of a triol with three moles of diisocyanate. In some cases, the “modified” isocyanate is obtained by cycloaddition processes to yield dimers and trimers of the isocyanate, i.e., polyisocyanates. Other methods for modifying isocyanates are described in Ullmann's Encyclopedia of Industrial Chemistry, Fifth Edition, 1989, Vol. A14, pages 611 to 625, and in U.S. Pat. No. 4,442,145 column 2, line 63 to column 3, line 31.

Free isocyanate groups are extremely reactive. In order to control the reactivity of isocyanate group-containing components, the NCO groups may be blocked with certain selected organic compounds that render the isocyanate group inert to reactive hydrogen compounds at room temperature. When heated to elevated temperatures, e.g., between 90 and 200° C., the blocked isocyanates release the blocking agent and react in the same way as the original unblocked or free isocyanate. The isocyanates used to prepare the coatings of the present invention can be fully blocked, as described in U.S. Pat. No. 3,984,299, column 1, line 57 through column 3, line 15, or partially blocked and reacted with the polymer backbone, as described in U.S. Pat. No. 3,947,338, column 2, line 65 to column 4, line 30.

As used herein, the NCO in the NCO:OH ratio represents the free isocyanate of free isocyanate-containing compounds, and of blocked or partially blocked isocyanate-containing compounds after the release of the blocking agent. In some cases, it is not possible to remove all of the blocking agent. In those situations, more of the blocked isocyanate-containing compound would be used to attain the desired level of free NCO.

The isocyanate component of the polyurethane coatings of the present invention may also include the polyiso(thio)cyanate compounds disclosed in U.S. Pat. No. 5,576,412.

In one contemplated embodiment, the isocyanate component is selected from the group of isocyanate-containing compounds consisting of aliphatic isocyanates, cycloaliphatic isocyanates, blocked aliphatic isocyanates, blocked cycloaliphatic isocyanates and mixtures of such isocyanates. In another contemplated embodiment, the isocyanate component is selected from the group consisting of blocked aliphatic isocyanates, blocked cycloaliphatic isocyanates and mixtures thereof. In still another contemplated embodiment, the isocyanate component is a blocked aliphatic isocyanate that includes the isocyanurate group, e.g., a blocked isocyanate component comprising blocked isocyanurates of isophorone diisocyanate.

Generally, compounds used to block the isocyanates are certain organic compounds that have active hydrogen atoms. Examples include volatile alcohols, amines, acidic esters, epsilon-caprolactam, triazoles, pyrazoles and ketoxime compounds. More specifically, the blocking compounds may be selected from the group consisting of methanol, t-butanol, phenol, cresol, nonylphenol, diisopropyl amine, malonic acid diethyl ester, acetoacetic acid ethyl ester, epsilon-caprolactam, 3-aminotriazole, 1,2,4-triazole, pyrazole, 3,5-dimethyl pyrazole, acetone oxime, methyl amyl ketoxime, methyl ethyl ketoxime and mixtures of these blocking agents. In one contemplated embodiment, the blocking compound is selected from the group consisting of methanol, diisopropyl amine, malonic acid diethyl ester, acetoacetic acid ethyl ester, 1,2,4-triazole, methyl ethyl ketoxime, acetone oxime and mixtures thereof. In another contemplated embodiment, the blocking compound is selected from the group consisting of methanol, diisopropyl amine, methyl ethyl ketoxime, 1,2,4-triazole and mixtures thereof.

Examples of isocyanate components include modified or unmodified members having free, blocked or partially blocked isocyanate-containing components of the group consisting of: toluene-2,4-diisocyanate; toluene-2,6-diisocyanate; diphenyl methane-4,4′-diisocyanate; diphenyl methane-2,4′-diisocyanate; para-phenylene diisocyanate; biphenyl diisocyanate; 3,3′-dimethyl-4,4′-diphenylene diisocyanate; tetramethylene-1,4-diisocyanate; hexamethylene-1,6-diisocyanate; 2,2,4-trimethyl hexane-1,6-diisocyanate; lysine methyl ester diisocyanate; bis(isocyanato ethyl)fumarate; isophorone diisocyanate; ethylene diisocyanate; dodecane-1,12-diisocyanate; cyclobutane-1,3-diisocyanate; cyclohexane-1,3-diisocyanate; cyclohexane-1,4-diisocyanate; dicyclohexylmethane-4,4-diisocyanate; methyl cyclohexyl diisocyanate; hexahydrotoluene-2,4-diisocyanate; hexahydrotoluene-2,6-diisocyanate; hexahydrophenylene-1,3-diisocyanate; hexahydrophenylene-1,4-diisocyanate; m-tetramethylxylene diisocyanate; p-tetramethylxylene diisocyanate; perhydrodiphenylmethane-2,4′-diisocyanate; perhydrodiphenylmethane-4,4′-diisocyanate and mixtures thereof. In one contemplated embodiment, the aforedescribed isocyanate component is selected from the group consisting of hexamethylene-1,6-diisocyanate; dicyclohexylmethane-4,4-diisocyanate; isophorone diisocyanate; ethylene diisocyanate; m-tetramethylxylene diisocyanate; p-tetramethylxylene diisocyanate; dodecane-1,12-diisocyanate; cyclohexane-1,3-diisocyanate, and mixtures thereof. In another contemplated embodiment, the isocyanate component is selected from the group consisting of hexamethylene-1,6-diisocyanate, isophorone diisocyanate, m-tetramethylxylene diisocyanate, dicyclohexylmethane-4,4-diisocyanate, ethylene diisocyanate and mixtures thereof.

The optional catalyst of the present invention may be selected from the group consisting of Lewis bases, Lewis acids and insertion catalysts described in Ullmann's Encyclopedia of Industrial Chemistry, 5th Edition, 1992, Volume A21, pp. 673 to 674. In one contemplated embodiment, the catalyst is selected from the group consisting of tin octylate, dibutyltin diacetate, dibutyltin dilaurate, dibutyltin mercaptide, dibutyltin dimaleate, dimethyltin diacetate, dimethyltin dilaurate, dimethyltin mercaptide, dimethyltin dimaleate, triphenyltin acetate, triphenyltin hydroxide, 1,4-diazabicyclo[2.2.2]octane, triethylamine and mixtures thereof. In another contemplated embodiment, the catalyst is selected from the group consisting of 1,4-diazabicyclo[2.2.2]octane, dibutyltin diacetate, dibutyltin dilaurate and mixtures thereof.

The organic polyol, i.e., diol, triol, etc., component(s) used to prepare the coating composition of the present invention are the aforedescribed polycarbonate polyol(s) and optionally, other different polyol(s) described hereinafter (that have a molecular weight of at least 500 grams per mole) that can react with an isocyanate component to produce a polyurethane. Typically, these polyols have a molecular weight not more than 10,000 grams per mole. The organic polyols described herein may also be used to form prepolymers or adducts with the isocyanates. The polyurethane coating of the present invention is produced by balancing the hard and soft segments comprising the polyurethane. By producing coatings in which the ratio of the equivalents of the hard segment-producing polyol to the soft segment-producing polyol is varied, one of ordinary skill in the art can readily identify which combination of hard segment and soft segment polyols yields a coating with a Fischer microhardness in the range of from 50 to 150 Newtons per mm² by measuring the Fischer microhardness of the resulting coatings. In a similar manner, one may identify which combinations of hard segment and soft segment polyols yields a coating that demonstrates the requisite photochromic performance properties and what amount of polycarbonate polyol results in a reduction of percent swell. It is contemplated that the organic polyol component may be a single polycarbonate polyol composed itself of sections of hard and soft segment-producing polyols.

In one contemplated embodiment, the organic polyol component comprises hard segment-producing polyols selected from the group consisting of polyacrylic polyols, epoxy polyols, amide containing polyols, urethane polyols and mixtures thereof that contribute from 0 to 90 percent of the hydroxyl groups that react with the isocyanate groups, and soft segment-producing polyols selected from the group consisting of polycarbonate polyols, polyether polyols, polyester polyols and mixtures thereof that contribute from 100 to 10 percent of the hydroxyl groups that react with the isocyanate groups. Stated otherwise, the hydroxyl equivalent ratio of hard segment-producing polyols to soft segment-producing polyols is from 0:100 to 90:10. In another contemplated embodiment, the hard segment-producing polyol is a polyacrylic polyol that is a copolymer of hydroxy-functional ethylenically unsaturated (meth)acrylic monomers and other ethylenically unsaturated monomers; and the soft segment-producing polyol is a polyol component selected from the group consisting of polycarbonate polyols and combinations of polycarbonate polyols with polyether and/or polyester polyols. When only one organic polycarbonate polyol is used to provide the hard and soft segment, the same ratios apply to the hard and soft segment-producing sections of that polyol.

Combinations of certain hard segment-producing and soft segment-producing polyols within the aforedescribed hydroxyl ratio ranges may be used to produce photochromic polyurethane coatings which exhibit acceptable Fischer microhardness levels and unacceptable photochromic performance properties and vice versa.

Examples of organic polyols that may be used in the present invention in addition to the aforedescribed polycarbonate polyols include (a) polyester polyols; (b) polyether polyols; (c) amide-containing polyols; (d) polyacrylic polyols; (e) epoxy polyols; (f) polyhydric polyvinyl alcohols; (g) urethane polyols; and (h) mixtures of such polyols. In one contemplated embodiment, the additional organic polyols are selected from the group consisting of polyacrylic polyols, polyether polyols, polyester polyols, urethane polyols and mixtures thereof. In another contemplated embodiment, the additional organic polyols are selected from the group consisting of polyacrylic polyols, polyether polyols, urethane polyols and mixtures thereof.

Polyester polyols are generally known and can have a number average molecular weight in the range of from 500 to 10,000. They are prepared by conventional techniques utilizing low molecular weight diols, triols and polyhydric alcohols known in the art, including but not limited to the previously described polyols used in the preparation of polycarbonate polyols (optionally in combination with monohydric alcohols) with polycarboxylic acids. Examples of suitable polycarboxylic acids include: phthalic acid, isophthalic acid, terephthalic acid, trimellitic acid, tetrahydrophthalic acid, adipic acid, succinic acid, glutaric acid, fumaric acid, and mixtures thereof. Anhydrides of the above acids, where they exist, can also be employed and are encompassed by the term “polycarboxylic acid”. In addition, certain materials which react in a manner similar to acids to form polyester polyols are also useful. Such materials include lactones, e.g., caprolactone, propiolactone and butyrolactone, and hydroxy acids such as hydroxycaproic acid and dimethylol propionic acid. If a triol or polyhydric alcohol is used, a monocarboxylic acid, such as acetic acid and/or benzoic acid, may be used in the preparation of the polyester polyols, and for some purposes, such a polyester polyol may be desirable. Moreover, polyester polyols are understood herein to include polyester polyols modified with fatty acids or glyceride oils of fatty acids (i.e., conventional alkyd polyols containing such modification). Another polyester polyol which may be utilized is one prepared by reacting an alkylene oxide, e.g., ethylene oxide, propylene oxide, etc., and the glycidyl esters of versatic acid with methacrylic acid to form the corresponding ester.

Polyether polyols are generally known and can have a number average molecular weight in the range of from 500 to 10,000 grams per mole. Examples of polyether polyols include various polyoxyalkylene polyols, polyalkoxylated polyols having a molecular weight greater than 500 grams per mole, e.g., poly(oxytetramethylene)diols, and mixtures thereof. The polyoxyalkylene polyols can be prepared, according to well-known methods, by condensing alkylene oxide, or a mixture of alkylene oxides using acid or base catalyzed addition, with a polyhydric initiator or a mixture of polyhydric initiators such as ethylene glycol, propylene glycol, glycerol, sorbitol and the like. Illustrative alkylene oxides include ethylene oxide, propylene oxide, butylene oxide, amylene oxide, aralkylene oxides, e.g., styrene oxide, and the halogenated alkylene oxides such as trichlorobutylene oxide and so forth. The more preferred alkylene oxides include propylene oxide and ethylene oxide or a mixture thereof using random or step-wise oxyalkylation. Examples of such polyoxyalkylene polyols include polyoxyethylene, i.e., polyethylene glycol, polyoxypropylene, i.e., polypropylene glycol. The molecular weight of such polyoxyalkylene polyols used as the soft segment is preferably equal to or greater than 600, more preferably, equal to or greater than 725, and most preferably, equal to or greater than 1000 grams per mole.

Polyalkoxylated polyols having a number average molecular weight greater than 500 grams per mole may be represented by the following general formula III,

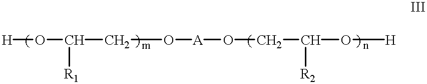

wherein m and n are each a positive number, the sum of m and n being from 5 to 70, R₁ and R₂ are each hydrogen, methyl or ethyl, preferably hydrogen or methyl and A is a divalent linking group selected from the group consisting of straight or branched chain alkylene (usually containing from 1 to 8 carbon atoms), phenylene, C₁-C₉ alkyl substituted phenylene and a group represented by the following general formula IV,

[chemical structure]

wherein R₃ and R₄ are each C₁-C₄ alkyl, chlorine or bromine, p and q are each an integer from 0 to 4,

[chemical structure]

represents a divalent benzene group or a divalent cyclohexane group, and D is O, S, —S(O₂)—, —C(O)—, —CH₂—, —CH═CH—, —C(CH₃)₂—, —C(CH₃)(C₆H₅)— or

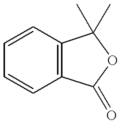

when

[chemical structure]

is the divalent benzene group, and D is O, S, —CH₂—, or —C(CH₃)₂— when

[chemical structure]

is the divalent cyclohexane group. In one contemplated embodiment, the polyalkoxylated polyol is one wherein the sum of m and n is from 15 to 40, e.g., 25 to 35, R₁ and R₂ are each hydrogen, and A is a divalent linking group according to general formula IV wherein

[chemical structure]

represents a divalent benzene group, p and q are each 0, and D is —C(CH₃)₂—. In another contemplated embodiment, the sum of m and n is from 25 to 35, e.g., 30. Such materials may be prepared by methods which are well known in the art. One such commonly used method involves reacting a polyol, e.g., 4,4′-isopropylidenediphenol, with an oxirane containing substance, for example ethylene oxide, propylene oxide, α-butylene oxide or β-butylene oxide, to form what is commonly referred to as an ethoxylated, propoxylated or butoxylated polyol having hydroxy functionality.

Examples of polyols that may be used in preparing the polyalkoxylated polyols include the polyols used in the preparation of the polycarbonate polyols described herein, e.g., trimethylolpropane and pentaerythritol; phenylene diols such as ortho, meta and para dihydroxy benzene; alkyl substituted phenylene diols such as 2,6-dihydroxytoluene, 3-methylcatechol, 4-methylcatechol, 2-hydroxybenzyl alcohol, 3-hydroxybenzyl alcohol, and 4-hydroxybenzyl alcohol; dihydroxybiphenyls such as 4,4′-dihydroxybiphenyl and 2,2′-dihydroxybiphenyl; bisphenols such as 4,4′-isopropylidenediphenol; 4,4′-oxybisphenol; 4,4′-dihydroxybenzenephenone; 4,4′-thiobisphenol; phenolphthalein; bis(4-hydroxyphenyl)methane; 4,4′-(1,2-ethenediyl)bisphenol; and 4,4′-sulfonylbisphenol; halogenated bisphenols such as 4,4′-isopropylidenebis(2,6-dibromophenol), 4,4′-isopropylidenebis(2,6-dichlorophenol) and 4,4′-isopropylidenebis(2,3,5,6-tetrachlorophenol); and biscyclohexanols, which can be prepared by hydrogenating the corresponding bisphenols, such as 4,4′-isopropylidene-iscyclohexanol; 4,4′-oxybiscyclohexanol; 4,4′-thiobiscyclohexanol; and bis(4-hydroxycyclohexanol)methane.

The polyether polyols also include the generally known poly(oxytetramethylene)diols prepared by the polymerization of tetrahydrofuran in the presence of Lewis acid catalysts such as boron trifluoride, tin (IV) chloride and sulfonyl chloride. The number average molecular weight of poly(oxytetramethylene)diols used as the soft segment ranges from 500 to 5000. In one contemplated embodiment, the number average molecular weight ranges from 650 to 2900, in another from 1000 to 2000, and in a further contemplated embodiment, 1000 grams per mole.

In one contemplated embodiment, the polyether polyols are selected from the group consisting of polyoxyalkylene polyols, polyalkoxylated polyols, poly(oxytetramethylene)diols and mixtures thereof. In another contemplated embodiment, the polyether polyols are selected from the group consisting of polyoxyalkylene polyols having a number average molecular weight of equal to or greater than 1,000 grams per mole, ethoxylated Bisphenol A having approximately 30 ethoxy groups, poly(oxytetramethylene) diols having a number average molecular weight of 1000 grams per mole and mixtures thereof.

Amide-containing polyols are generally known and typically are prepared from the reaction of diacids or lactones and polyols used in the preparation of polycarbonate polyols described herein with diamines or aminoalcohols as described hereinafter. For example, amide-containing polyols may be prepared by the reaction of neopentyl glycol, adipic acid and hexamethylenediamine. The amide-containing polyols may also be prepared through aminolysis by the reaction, for example, of carboxylates, carboxylic acids, or lactones with amino alcohols. Examples of suitable diamines and amino alcohols include hexamethylenediamines, ethylenediamines, phenylenediamine, monoethanolamine, diethanolamine, isophorone diamine and the like.

Epoxy polyols are generally known and can be prepared, for example, by the reaction of glycidyl ethers of polyphenols such as the diglycidyl ether of 2,2-bis(4-hydroxyphenyl)propane, with polyphenols such as 2,2-bis(4-hydroxyphenyl)propane. Epoxy polyols of varying molecular weights and average hydroxyl functionality can be prepared depending upon the ratio of starting materials used.

Polyhydric polyvinyl alcohols are generally known and can be prepared, for example, by the polymerization of vinyl acetate in the presence of suitable initiators followed by hydrolysis of at least a portion of the acetate moieties. In the hydrolysis process, hydroxyl groups are formed which are attached directly to the polymer backbone. In addition to homopolymers, copolymers of vinyl acetate and monomers such as vinyl chloride can be prepared and hydrolyzed in similar fashion to form polyhydric polyvinyl alcohol-polyvinyl chloride copolymers.

Urethane polyols are generally known and can be prepared, for example, by reaction of a polyisocyanate with excess organic polyol to form a hydroxyl functional product. Examples of polyisocyanates useful in the preparation of urethane polyols include those described herein. Examples of organic polyols useful in the preparation of urethane polyols include the other polyols described herein, e.g., low molecular weight polyols, polyester polyols, polyether polyols, amide-containing polyols, polyacrylic polyols, epoxy polyols, polyhydric polyvinyl alcohols and mixtures thereof.

The polyacrylic polyols are generally known and can be prepared by free-radical addition polymerization techniques of monomers described hereinafter. In one contemplated embodiment, polyacrylic polyols have a weight average molecular weight of from 500 to 50,000 and a hydroxyl number of from 20 to 270. In another contemplated embodiment, the weight average molecular weight is from 1000 to 30,000 and the hydroxyl number is from 80 to 250. In still another contemplated embodiment, the weight average molecular weight is from 3,000 to 20,000 and the hydroxyl number is from 100 to 225

Polyacrylic polyols include, but are not limited to, the known hydroxyl-functional addition polymers and copolymers of acrylic and methacrylic acids; their ester derivatives including, but not limited to, their hydroxyl-functional ester derivatives. Examples of hydroxy-functional ethylenically unsaturated monomers to be used in the preparation of the hydroxy-functional addition polymers include hydroxyethyl (meth)acrylate, i.e., hydroxyethyl acrylate and hydroxyethyl methacrylate, hydroxypropyl (meth)acrylate, hydroxybutyl (meth)acrylate, hydroxymethylethyl acrylate, hydroxymethylpropyl acrylate and mixtures thereof.

In one contemplated embodiment, the polyacrylic polyol is a copolymer of hydroxy-functional ethylenically unsaturated (meth)acrylic monomers and other ethylenically unsaturated monomers selected from the group consisting of vinyl aromatic monomers, e.g., styrene, α-methyl styrene, t-butyl styrene and vinyl toluene; vinyl aliphatic monomers such as ethylene, propylene and 1,3-butadiene; (meth)acrylamide; (meth)acrylonitrile; vinyl and vinylidene halides, e.g., vinyl chloride and vinylidene chloride; vinyl esters, e.g., vinyl acetate; alkyl esters of acrylic and methacrylic acids, i.e. alkyl esters of (meth)acrylic acids, having from 1 to 17 carbon atoms in the alkyl group, including methyl (meth)acrylate, ethyl (meth)acrylate, butyl (meth)acrylate, cyclohexyl (meth)acrylate, 2-ethylhexyl (meth)acrylate, isobornyl (meth)acrylate and lauryl (meth)acrylate; epoxy-functional ethylenically unsaturated monomers such as glycidyl (meth)acrylate; carboxy-functional ethylenically unsaturated monomers such as acrylic and methacrylic acids and mixtures of such ethylenically unsaturated monomers.

The hydroxy-functional ethylenically unsaturated (meth)acrylic monomer(s) may comprise up to 95 weight percent of the polyacrylic polyol copolymer. In one contemplated embodiment, it composes up to 70 weight percent, and in another, the hydroxy-functional ethylenically unsaturated (meth)acrylic monomer(s) comprises up to 45 weight percent of the total copolymer.

The polyacrylic polyols described herein can be prepared by free radical initiated addition polymerization of the monomer(s), and by organic solution polymerization techniques. The monomers are typically dissolved in an organic solvent or mixture of solvents including ketones such as methyl ethyl ketones, esters such as butyl acetate, the acetate of propylene glycol, and hexyl acetate, alcohols such as ethanol and butanol, ethers such as propylene glycol monopropyl ether and ethyl-3-ethoxypropionate, and aromatic solvents such as xylene and SOLVESSO 100, a mixture of high boiling hydrocarbon solvents available from Exxon Chemical Co. The solvent is first heated to reflux, usually 70 to 160° C., and the monomer or a mixture of monomers and free radical initiator is slowly added to the refluxing solvent, over a period of about 1 to 7 hours. Adding the monomers too quickly may cause poor conversion or a high and rapid exothermic reaction, which is a safety hazard. Suitable free radical initiators include t-amyl peroxyacetate, di-t-amyl peroxyacetate and 2,2′-azobis (2-methylbutanenitrile). The free radical initiator is typically present in the reaction mixture at from 1 to 10 percent, based on total weight of the monomers. The polymer prepared by the procedures described herein is non-gelled and preferably has a molecular weight of from 500 to 50,000 grams per mole.

Photochromic compounds that may be utilized with the polyurethane coating compositions of the present invention are organic photochromic compounds that color to a desired hue. They typically have at least one activated absorption maxima within the range of between about 400 and 700 nanometers. They may be used individually or may be used in combination with photochromic compounds that complement their activated color. Further, the photochromic compounds may be incorporated, e.g., dissolved or dispersed, in the polyurethane coating composition, which is used to prepare photochromic articles.

The organic photochromic materials may include naphthopyrans, benzopyrans, indenonaphthopyrans, phenanthorpyrans, spiro(benzindoline)naphthopyrans, spiro(indoline)benzopyrans, spiro(indoline)naphthopyrans, spiro(indoline)quinopyrans, spiro(indoline)pyrans, spiro(indoline)naphthoxazines, spiro(indoline)pyridobenzoxazines, spiro(benzindoline)pyridobenzoxazines, spiro(benzindoline)naphthoxazines, spiro(indoline)benzoxazines, mercury dithizonates, fulgides, fulgimides and mixtures of such photochromic compounds. Such photochromic compounds are described in U.S. Pat. Nos. 5,645,767 and 6,153,126.

The photochromic compounds described herein are used in photochromic amounts and in a ratio (when mixtures are used) such that a coating composition to which the compound(s) is applied or in which it is incorporated exhibits a desired resultant color, e.g., a substantially neutral color such as shades of gray or brown when activated with unfiltered sunlight, i.e., as near a neutral color as possible given the colors of the activated photochromic compounds, and exhibits the desired intensity, as measured by the change in optical density (ΔOD), e.g., a ΔOD of 0.28 or more when tested at 85° F. after 8 minutes of activation using the 85° F. Photochromic Performance Test described in Part E of Example 15. Neutral gray and neutral brown colors are preferred; however, other fashionable colors may be used. Further discussion of neutral colors and ways to describe colors may be found in U.S. Pat. No. 5,645,767 column 12, line 66 to column 13, line 19.

Generally, the amount of photochromic material incorporated into the coating composition ranges from 0.1 to 40 weight percent based on the weight of the liquid coating composition. Preferably, the concentration of photochromic material ranges from 1.0 to 30 weight percent, more preferably, from 3 to 20 weight percent, and most preferably, from 5 to 15 weight percent, e.g., from 7 to 14 weight percent, based on the weight of the liquid coating composition. The concentration of photochromic material may range between any combination of these values, inclusive of the recited ranges, e.g., from 0.15 to 39.95 weight percent.

The photochromic compound(s) described herein may be incorporated into the coating composition by dissolving or dispersing the photochromic substance within the organic polyol component or the isocyanate component, or by adding it to a mixture of the polyurethane-forming components. Alternatively, the photochromic compounds may be incorporated into the cured coating by imbibition, permeation or other transfer methods as known by those skilled in the art.

Compatible (chemically and color-wise) tints, i.e., dyes, may be added to the coating composition, applied to the coated article or applied to the substrate prior to coating to achieve a more aesthetic result, for medical reasons, or for reasons of fashion. The particular dye selected will vary and depend on the aforesaid need and result to be achieved. In one embodiment, the dye may be selected to complement the color resulting from the activated photochromic substances, e.g., to achieve a more neutral color or absorb a particular wavelength of incident light. In another embodiment, the dye may be selected to provide a desired hue to the substrate and/or coated article when the photochromic substances are in an unactivated state.

Adjuvant materials may also be incorporated into the coating composition with the photochromic material used, prior to, simultaneously with or subsequent to application or incorporation of the photochromic material in the coating composition or cured coating. For example, ultraviolet light absorbers may be admixed with photochromic substances before their addition to the coating composition or such absorbers may be superposed, e.g., superimposed, as a layer between the photochromic coating and the incident light. Further, stabilizers may be admixed with the photochromic substances prior to their addition to the coating composition to improve the light fatigue resistance of the photochromic substances. Stabilizers, such as hindered amine light stabilizers (HALS), asymmetric diaryloxalamide (oxanilide) compounds and singlet oxygen quenchers, e.g., a nickel ion complex with an organic ligand, polyphenolic antioxidants or mixtures of such stabilizers are contemplated. They may be used alone or in combination. Such stabilizers are described in U.S. Pat. Nos. 4,720,356, 5,391,327 and 5,770,115.

The photochromic polyurethane coating composition of the present invention may further comprise additional conventional ingredients which impart desired characteristics to the composition, or which are required for the process used to apply and cure the composition to the substrate or which enhance the cured coating made therefrom. For example, plasticizers may be used to adjust the Fischer microhardness and/or photochromic performance properties of a photochromic polyurethane coating composition that produced a cured coating having results for such properties outside of the desired range. Other such additional ingredients comprise rheology control agents, leveling agents, e.g., surfactants, initiators, cure-inhibiting agents, free radical scavengers and adhesion promoting agents, such as trialkoxysilanes preferably having an alkoxy substituent of 1 to 4 carbon atoms, including γ-glycidoxypropyltrimethoxysilane, γ-aminopropyltrimethoxysilane, 3,4-epoxycyclohexylethyltrimethoxysilane and aminoethyltrimethoxysilane.

The coating compositions used in accordance with the invention may be applied to substrates, i.e., materials to which the coating composition is applied, of any type such as, for example paper, glass, ceramics, wood, masonry, textiles, metals and organic polymeric materials. In one contemplated embodiment, the substrate is an organic polymeric material, particularly, thermoset and thermoplastic organic polymeric materials, e.g., thermoplastic polycarbonate type polymers and copolymers, and homopolymers or copolymers of a polyol(allyl carbonate), used as organic optical materials.

The amount of the coating composition applied to the substrate is an amount necessary to incorporate a sufficient quantity of the organic photochromic compound(s) to produce a coating that exhibits the required change in optical density (ΔOD) when the cured coating is exposed to UV radiation. The cured coating may have a thickness of from 5 to 200 microns. Preferably, the coating thickness is from 5 to 100 microns, more preferably, 10 to 40 microns, e.g., 30 microns, and most preferably from greater than 10 to 25 microns, e.g., 20 microns. The thickness of the applied coating may range between any combination of these values, inclusive of the recited values.

If required and if appropriate, it is typical to clean the surface of the substrate to be coated prior to applying the coating composition of the present invention for the purposes of promoting adhesion of the coating. Effective treatment techniques for plastics, such as those prepared from diethylene glycol bis(allyl carbonate) monomer or thermoplastic polycarbonate, e.g., a resin derived from bisphenol A and phosgene, include ultrasonic cleaning; washing with an aqueous mixture of organic solvent, e.g., a 50:50 mixture of isopropanol:water or ethanol:water; UV treatment; activated gas treatment, e.g., treatment with low temperature plasma or corona discharge, and chemical treatment such as hydroxylation, i.e., etching of the surface with an aqueous solution of alkali, e.g., sodium hydroxide or potassium hydroxide, that may also contain a fluorosurfactant. See U.S. Pat. No. 3,971,872, column 3, lines 13 to 25; U.S. Pat. No. 4,904,525, column 6, lines 10 to 48; and U.S. Pat. No. 5,104,692, column 13, lines 10 to 59, which describe surface treatments of organic polymeric materials.

The treatment used for cleaning glass surfaces will depend on the type of dirt present on the glass surface. Such treatments are known to those skilled in the art. For example, washing the glass with an aqueous solution that may contain a low foaming, easily rinsed detergent, followed by rinsing and drying with a lint-free cloth; and ultrasonic bath treatment in heated (about 50° C.) wash water, followed by rinsing and drying. Pre-cleaning with an alcohol-based cleaner or organic solvent prior to washing may be required to remove adhesives from labels or tapes.

In some cases, it may be necessary to apply a primer to the surface of the substrate before application of the coating composition of the present invention. The primer serves as a barrier coating to prevent interaction of the coating ingredients with the substrate and vice versa, and/or as an adhesive layer to adhere the coating composition to the substrate. Application of the primer may be by any of the methods used in coating technology such as, for example, spray coating, spin coating, spread coating, dip coating, casting or roll-coating.

The use of protective coatings, some of which may contain polymer-forming organosilanes, as primers to improve adhesion of subsequently applied coatings has been described. In particular, the use of non-tintable coatings is preferred. Examples of commercial coating products include SILVUE® 124 and HI-GARD® coatings, available from SDC Coatings, Inc. and PPG Industries, Inc., respectively. In addition, depending on the intended use of the coated article, it may be necessary to apply an appropriate protective coating(s), i.e., an abrasion resistant coating and/or coatings that serve as oxygen barriers, onto the exposed surface of the coating composition to prevent scratches from the effects of friction and abrasion and interactions of oxygen with the photochromic compounds, respectively. In some cases, the primer and protective coatings are interchangeable, i.e., the same coating may be used as the primer and the protective coating(s). Hardcoats based on inorganic materials such as silica, titania and/or zirconia as well as organic hardcoats of the type that are ultraviolet light curable may be used.

In one contemplated embodiment, the article of the present invention comprises, in combination, a substrate, a photochromic polyurethane coating exhibiting less than 25% swell in the Percent Swelling Test, and a protective hardcoat. The protective hardcoat being an organosilane hardcoat.

Other coatings or surface treatments, e.g., a tintable coating, antireflective surface, etc., may also be applied to the photochromic articles of the present invention. An antireflective coating, e.g., a monolayer or multilayer of metal oxides, metal fluorides, or other such materials, may be deposited onto the photochromic articles, e.g., lenses, of the present invention through vacuum evaporation, sputtering, or some other method.

The coating composition of the present invention may be applied using the same methods described herein for applying the primer and the protective coating(s) or other methods known in the art can be used. Preferably, the coating composition is applied by spin coating, dip coating or spray coating methods, and most preferably, by spin coating methods.

Following application of the coating composition to the treated surface of the substrate, the coating is cured. Depending on the isocyanate component selected, i.e., free, blocked or partially blocked, the coating may be cured at temperatures ranging from 22° C. to 200° C. If heating is required to obtain a cured coating, temperatures of between 80° C. and a temperature above which the substrate is damaged due to heating, e.g., 80° C. to 150° C., are typically used. For example, certain organic polymeric materials may be heated up to 130° C. for a period of 1 to 16 hours in order to cure the coating without causing damage to the substrate. While a range of temperatures has been described for curing the coated substrate, it will be recognized by persons skilled in the art that temperatures other than those disclosed herein may be used. Additional methods for curing the photochromic polyurethane coating composition include irradiating the coating with infrared, ultraviolet, gamma or electron radiation so as to initiate the polymerization reaction of the polymerizable components in the coating. This may be followed by a heating step.

In accordance with the present invention, the cured polyurethane coating meets commercially acceptable “cosmetic” standards for optical coatings. Examples of cosmetic defects found in optical coatings include orange peel, pits, spots, inclusions, cracks and crazing of the coating. Definitions of these and other such coating defects are found in the Paint/Coating Dictionary, by the Federation of Societies for Coating Technology, Philadelphia, Pa. In one embodiment, the coatings prepared using the photochromic polyurethane coating composition of the present invention are substantially free of cosmetic defects detectable by un-aided visual examination, i.e., no magnification.

The organic polymeric material that may be a substrate for the coating composition of the present invention will usually be transparent, but may be translucent or even opaque. Preferably, the polymeric organic material is a solid transparent or optically clear material, e.g., materials suitable for optical applications, such as plano, ophthalmic and contact lenses, windows, automotive transparencies, e.g., windshields, aircraft transparencies, plastic sheeting, polymeric films, etc.

Examples of polymeric organic materials which may be used as a substrate for the photochromic coating composition described herein include: polymers, i.e., homopolymers and copolymers, of the bis(allyl carbonate) monomers, diethylene glycol dimethacrylate monomers, diisopropenyl benzene monomers, ethoxylated bisphenol A dimethacrylate monomers, ethylene glycol bismethacrylate monomers, poly(ethylene glycol) bismethacrylate monomers, ethoxylated phenol bismethacrylate monomers, alkoxylated polyhydric alcohol acrylate monomers, such as ethoxylated trimethylol propane triacrylate monomers, urethane acrylate monomers, such as those described in U.S. Pat. No. 5,373,033, and vinylbenzene monomers, such as those described in U.S. Pat. No. 5,475,074 and styrene; polymers, i.e., homopolymers and copolymers, mono- or polyfunctional, e.g., di- or multi-functional, acrylate and/or methacrylate monomers, poly(C₁-C₁₂ alkyl methacrylates), such as poly(methyl methacrylate), poly(oxyalkylene)dimethacrylate, poly(alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), polyurethanes, polythiourethanes, thermoplastic polycarbonates, polyesters, poly(ethylene terephthalate), polystyrene, poly(alpha methylstyrene), copoly(styrene-methyl methacrylate), copoly(styrene-acrylonitrile), polyvinylbutyral and polymers, i.e., homopolymers and copolymers, of diallylidene pentaerythritol, particularly copolymers with polyol (allyl carbonate) monomers, e.g., diethylene glycol bis(allyl carbonate), and acrylate monomers, e.g., ethyl acrylate, butyl acrylate. Further examples of polymeric organic host materials are disclosed in the U.S. Pat. No. 5,753,146, column 8, line 62 to column 10, line 34.

Transparent copolymers and blends of transparent polymers are also suitable as polymeric materials. Preferably, the substrate for the photochromic coating composition is an optically clear polymerized organic material prepared from a thermoplastic polycarbonate resin, such as the carbonate-linked resin derived from bisphenol A and phosgene, which is sold under the trademark, LEXAN; a polyester, such as the material sold under the trademark, MYLAR; a poly(methyl methacrylate), such as the material sold under the trademark, PLEXIGLAS; polymerizates of a polyol(allyl carbonate) monomer, especially diethylene glycol bis(allyl carbonate), which monomer is sold under the trademark CR-39, and polymerizates of copolymers of a polyol (allyl carbonate), e.g., diethylene glycol bis(allyl carbonate), with other copolymerizable monomeric materials, such as copolymers with vinyl acetate, e.g., copolymers of from 80-90 percent diethylene glycol bis(allyl carbonate) and 10-20 percent vinyl acetate, particularly 80-85 percent of the bis(allyl carbonate) and 15-20 percent vinyl acetate, and copolymers with a polyurethane having terminal diacrylate functionality, as described in U.S. Pat. Nos. 4,360,653 and 4,994,208; and copolymers with aliphatic urethanes, the terminal portion of which contain allyl or acrylyl functional groups, as described in U.S. Pat. No. 5,200,483; poly(vinyl acetate), polyvinylbutyral, polyurethane, polythiourethanes, polymers of members of the group consisting of diethylene glycol dimethacrylate monomers, diisopropenyl benzene monomers, ethoxylated bisphenol A dimethacrylate monomers, ethylene glycol bismethacrylate monomers, poly(ethylene glycol) bismethacrylate monomers, ethoxylated phenol bismethacrylate monomers and ethoxylated trimethylol propane triacrylate monomers; cellulose acetate, cellulose propionate, cellulose butyrate, cellulose acetate butyrate, polystyrene and copolymers of styrene with methyl methacrylate, vinyl acetate and acrylonitrile.

More particularly contemplated, is the use of optically clear polymerizates, i.e., materials suitable for optical applications, such as optical elements, e.g., plano and vision correcting ophthalmic lenses, windows, clear polymeric films, automotive transparencies, e.g., windshields, aircraft transparencies, plastic sheeting, etc. Such optically clear polymerizates may have a refractive index that may range from 1.48 to 1.75, e.g., from 1.495 to 1.66, particularly from 1.5 to 1.6. Specifically contemplated are optical elements made of thermoplastic polycarbonates.

Most particularly contemplated, is the use of a combination of the photochromic polyurethane coating composition of the present invention with optical elements to produce photochromic optical articles. Such articles are prepared by sequentially applying to the optical element a primer, the photochromic polyurethane composition of the present invention and appropriate protective coating(s). The resulting cured coating meets commercially acceptable “cosmetic” standards for optical coatings.

The present invention is more particularly described in the following examples, which are intended as illustrative only, since numerous modifications and variations therein will be apparent to those skilled in the art. Identically numbered footnotes in the tables found in the examples refer to identical substances.

### COMPOSITION A

The following materials were added to a three neck baffled reaction flask equipped with a Teflon paddle stirrer, thermometer and an addition funnel: dichloromethane (360 grams), diethylene glycol bischloroformate (115.5 grams, 0.500 mole), 1,8-octanediol (60.7 grams, 0.415 mole) and quaternary butyl ammonium bromide (0.6 gram). The resulting mixture was stirred at 620 rpm. The reaction flask was placed into an ice/water bath to control the temperature of the mixture during the exothermic reaction. After the temperature of the reaction mixture reached 20 to 22° C., 50 weight percent aqueous sodium hydroxide (140 grams) was added to the reaction flask over 70 minutes. The reaction mixture was stirred for an additional 2 hours and the temperature of the resulting mixture was 24° C. Water (300 mL) was added and the reaction mixture was stirred for 10 to 20 minutes. The contents of the reaction flask were transferred to a separatory funnel and the organic phase was separated. The organic phase was washed with 10 weight percent aqueous sodium chloride (300 mL) twice and with water (300 mL) once. The recovered product was sparged with nitrogen and the remaining volatiles were removed by heating the product to 90° C. and applying a vacuum for about 95 minutes. The colorless and very slightly hazy product, 111 grams, was determined to have an OH (hydroxyl) number of 103 and a molecular weight of 1089 grams per mole according to ASTME 1899-97 Standard Test Method for Hydroxyl Groups Using Reaction with p-Toulenesulfonyl Isocyanate (TSI) and Potentiometric Titration with Tetrabutylammonium Hydroxide. This procedure was used to determine the OH number and molecular weight of Compositions B-J.

### COMPOSITION B

The procedure used to prepare Composition A was followed except that 51.2 grams (0.350 mole) of 1,8-octanediol and 310 grams of dichloromethane were used and the 50 weight percent aqueous sodium hydroxide was added over 60 minutes after the temperature of the reaction mixture was within the range of 21 to 24° C. The clear and colorless recovered product, 109 grams, was determined to have an OH number of 78.6 and a molecular weight of 1427 grams per mole.

### COMPOSITION C

The procedure used to prepare Composition A was followed except for the following: 50.0 grams (0.378 mole) of 1,7-heptanediol was used in place of 1,8-octanediol; 300 grams of dichloromethane and 105.2 grams (0.455 mole) of diethylene glycol bischloroformate were used; and the 50 weight percent aqueous sodium hydroxide was added over 55 minutes. The clear very slightly pink recovered product, 102 grams, was determined to have an OH number of 58.1 and a molecular weight of 1931 grams per mole.

### COMPOSITION D

The procedure used to prepare Composition A was followed except that the following materials were used in the amounts specified: dichloromethane (320 grams), diethylene glycol bischloroformate (95 grams, 0.411 mole), poly(oxytetramethylene) diol having a molecular weight of 236 determined by Hydroxyl Number Titration, (87.3 grams) and quaternary butyl ammonium bromide (0.6 gram); the reaction mixture was stirred for three hours at 24.5° C.; and the product was heated to 120° C. under vacuum for 24 minutes. The clear and colorless recovered product, 128 grams, was determined to have an OH number of 59.3 and a molecular weight of 1892 grams per mole.

### COMPOSITION E

The procedure used to prepare Composition A was followed except that 1,9-nonanediol (65.0 grams) was used in place of 1,8-octanediol, 320 grams of dichloromethane and 112.9 grams of diethylene glycol bischloroformate were used and the volatiles were removed by heating the product to 115° C. and applying a vacuum for about 90 minutes. The slightly hazy recovered product, 126 grams, was determined to have an OH number of 85.9 and a molecular weight of 1306 grams per mole.

### COMPOSITION F

The procedure used to prepare Composition A was followed except that 1,10-decane diol (70.0 grams) was used in place of 1,8-octane diol and 320 grams of dichloromethane and 111.8 grams of diethylene glycol bischloroformate were used and the volatiles were removed by heating the product to 120° C. and applying a vacuum for about 120 minutes. The opaque waxy solid recovered, 88 grams, was determined to have an OH number of 97.5 and a molecualr weight of 1151 grams per mole.

### COMPOSITION G

The following materials were added in the order and manner described to a suitable reaction vessel equipped with a reflux column, agitator, an addition funnel, nitrogen inlet, vacuum distillation column, an internal mercury thermometer and a heating mantle controlled by a variable transformer:

| | |
|---|---|
| Material | Weight (grams) |

Charge-1

| | |
|---|---|
| 1,6-hexane diol | 282.92 |

Charge-2

| | |
|---|---|
| Diethyl carbonate | 272.42 |

Charge-3

| | |
|---|---|
| Tetrabutyl titanate | 0.216 |

Charge-4

| | |
|---|---|
| Diethyl carbonate | 30.0 |

Charge-1 was added to the reaction vessel and heated at 120° C. until it melted. Charge-2 was added and the reaction mixture was heated and stirred at 120° C. for 30 minutes. Charge-3 was added under rigorously dry, flowing nitrogen conditions. The resulting reaction mixture was refluxed for about 15 hours, distilled for about 7 hours and vacuum distilled for about 30 minutes. During the refluxing and distilling steps, the temperature of the reaction mixture was maintained between 120 and 150° C. Charge-4 was added and the contents of the reaction vessel were refluxed about 19 hours and distilled with nitrogen flowing for about 43 hours and vacuum distilled for about 4 hours. The contents of the reaction vessel were then cooled and transferred to a suitable container. The resulting clear polymer solution of 320.0 grams, which solidified to form a waxy solid, had a hydroxyl number of 59.5 and a molecular weight of 1886 grams per mole.

### COMPOSITION H

The procedure used to prepare Composition G was followed except that 1,5-pentanediol (248.8 grams) was used in place of 1,6-hexanediol; 278.4 grams of diethyl carbonate and 0.209 grams of tetrabutyl titanate were used in Charges 2 and 3, respectively; and 20 grams of diethyl carbonate was used in Charge 4. The times for refluxing, distilling and vacuum distilling after Charges 3 and 4 also differed from the time intervals used to prepare Composition D. After Charge-3, the material was refluxed for about 28 hours, distilled for about 26 hours and vacuum distilled for about 2 hours. After Charge-4, the material was distilled 115 hours and vacuum distilled for about 4 hours. The resulting brown polymer solution, 225.0 grams, which solidified to form a waxy solid, had a hydroxyl number of 63 and a molecular weight of 1781 grams per mole.

### COMPOSITION I

The procedure used to prepare Composition G was followed except that 1,4-butanediol (214.7 grams) was used in place of 1,6-hexanediol; 281.65 grams of diethyl carbonate and 0.195 grams of tetrabutyl titanate were used in Charges 2 and 3. The resulting polymer solution (163 grams), which solidified to form a white waxy solid, had a hydroxyl number of 72.4 and a molecular weight of 1550 grams per mole.

### COMPOSITION J

The following materials were added to a round bottom flask containing xylene in an amount sufficient to produce an 80 weight percent solution of reactants: Isophorone diisocyanate and PC-1122 in a NCO:OH equivalent ratio of 37:73, respectively, and dibutyl tin dilaurate catalyst at a level of 0.1 weight percent, based on the combined weight of isophorone diisocynate and PC-1122. The reaction mixture was heated to 70° C. and held at this temperature, typically from 2 to 4 hours, until the analysis of samples showed undetectable levels (less than 0.1 weight percent based on the total weight of the sample) by a disappearance of the NCO peak in the infra-red spectrum. The hydroxyl equivalent weight was determined to be 2183 and the molecular weight was 3492 grams per mole, based on total solids. Isophorone diisocyanate is an aliphatic polyisocyanate available from Crea Nova, Inc. PC-1122 is an aliphatic polycarbonate diol available from Stahl USA.

### COMPOSITION K

The following materials were added in the order and manner described to a suitable reaction vessel equipped with an agitator, a reflux column, an addition funnel, nitrogen inlet, an internal temperature probe connected to an external electronic controller and a heating mantle:

| | |
|---|---|
| Material | Weight (grams) |

Charge-1

| | |
|---|---|
| SOLVESSO 100 solvent⁽¹⁾ | 120 |
| Xylene | 120 |
| Isobutanol | 48 |

Charge-2

| | |
|---|---|
| Hydroxypropyl acrylate | 448 |
| Butyl acrylate | 212.8 |
| Butyl methacrylate | 207.2 |
| Styrene | 22.4 |
| Acrylic acid | 22.4 |
| Methyl methacrylate | 5.6 |
| Tertiary dodecyl mercaptan | 11.2 |

Charge-3

| | |
|---|---|
| Xylene | 96 |
| SOLVESSO 100 solvent⁽¹⁾ | 72 |
| VAZO-67 initiator⁽²⁾ | 56 |

Charge-4

| | |
|---|---|
| SOLVESSO 100 solvent⁽¹⁾ | 12 |
| VAZO-67 initiator⁽²⁾ | 4.5 |

Charge-5

| | |
|---|---|
| SOLVESSO 100 solvent⁽¹⁾ | 12 |
| VAZO-67 initiator⁽²⁾ | 4.5 |

⁽¹⁾Aromatic solvent available from Exxon.
⁽²⁾2,2′-azobis-(2-methylbutyronitrile) available from E.I. duPont de Nemours and Company.

Charge-1 was added to the reaction vessel; nitrogen was introduced into the vessel, and with the agitator running heat was applied to the reaction vessel to maintain a temperature at which reflux of the solvent occurred. After reaching the reflux temperature, Charges-2 and -3 were added separately to the reaction vessel in a continuous manner over a period of 2 hours. Subsequently, Charge-4 was added and the reaction mixture was held for 1 hour at the reflux temperature. Charge-5 was then added and the reaction mixture was held an additional 1.5 hours at the reflux temperature. The contents of the reaction vessel were then cooled and transferred to a suitable container. The resulting polymer solution had a calculated total solids content, based on total solution weight, of about 70.7 percent. The polymer had a weight average molecular weight, as measured by gel permeation chromatography using polystyrene as a standard, of about 9,000 and a hydroxyl number of about 170, based on polymer solids.

### COMPOSITION L

The following materials were added in the order listed to a container suitable for use with a BRINKMAN PT-3000 homogenizer.

| Material | Weight (grams) |
|---|---|
| Photochromic No. 1⁽³⁾ | 13.676 |
| Photochromic No. 2⁽⁴⁾ | 9.946 |
| Photochromic No. 3⁽⁵⁾ | 1.243 |
| TINUVIN 144 UV | 6.216 |
| stabilizer⁽⁶⁾ | |
| BAYSTLONE paint additive | 0.225 |
| PL⁽⁷⁾ | |
| NMP⁽⁸⁾ | 116.721 |
| SILQUEST A-187⁽⁹⁾ | 8.993 |

⁽³⁾A naphtho [1,2-b] pyran that exhibits a blue color when irradiated with ultraviolet light.
⁽⁴⁾A naphtho [1,2-b] pyran that exhibits a yellow-orange color when irradiated with ultraviolet light.
⁽⁵⁾A naphtho [1,2-b] pyran that exhibits a blue color when irradiated with ultraviolet light.
⁽⁶⁾Hindered amine ultraviolet light stabilizer available from CIBA-GEIGY Corp.
⁽⁷⁾Phenyl methyl polysiloxane available from Bayer Corporation.
⁽⁸⁾N-methyl pyrrolidone solvent of 99 percent purity.
⁽⁹⁾A γ-glycidoxypropyltrimethoxysilane available from OSi Specialties.

The resulting solution was placed in a 60° C. convection oven for about an hour or until all of the materials were dissolved.

### EXAMPLE 1

The following materials were added in the order and the manner described to a container suitable for use with a BRINKMAN PT-3000 homogenizer:

| Material | Weight (grams) |
|---|---|
| Composition L | 7.602 |
| Composition K | 1.789 |
| Composition I | 4.506 |
| VESTANAT B 1358A⁽¹⁰⁾ | 8.098 |
| Tin catalyst⁽¹¹⁾ | 0.109 |
| NMP | 0.966 |

⁽¹⁰⁾A methyl ethyl ketoxime blocked, aliphatic polyisocyanate available from CreaNova, Inc.
⁽¹¹⁾Dibutyltin dilaurate available as DABCO T-12 catalyst or METACURE T-12 catalyst.

The contents in the container were mixed for 2 minutes at 5000 rpm. The resulting solution was placed in a 60° C. convection oven for about an hour.

### EXAMPLE 2

The procedure of Example 1 was used with the following materials:

| Material | Weight (grams) |
|---|---|
| Composition L | 7.494 |
| Composition K | 2.684 |
| Composition C | 3.725 |
| VESTANAT B 1358A | 8.098 |
| Tin catalyst | 0.107 |
| NMP | 0.634 |

### EXAMPLE 3

The procedure of Example 1 was used with the following materials:

| Material | Weight (grams) |
|---|---|
| Composition L | 6.803 |
| Composition K | 1.342 |
| Composition A | 3.678 |
| VESTANAT B 1358A | 8.098 |
| Tin catalyst | 0.097 |
| NMP | 0.628 |

### EXAMPLE 4

The procedure of Example 1 was used with the following materials:

| Material | Weight (grams) |
|---|---|
| Composition L | 7.289 |
| Composition K | 2.684 |
| Composition H | 3.432 |
| VESTANAT B 1358A | 8.098 |
| Tin catalyst | 0.104 |
| NMP | 0.513 |

### EXAMPLE 5

The procedure of Example 1 was used with the following materials:

| Material | Weight (grams) |
|---|---|
| Composition L | 7.335 |
| Composition K | 1.789 |
| Composition B | 4.124 |
| VESTANAT B 1358A | 8.098 |
| Tin catalyst | 0.105 |
| NMP | 0.808 |

### EXAMPLE 6

The procedure of Example 1 was used with the following materials:

| Material | Weight (grams) |
|---|---|
| Composition L | 7.098 |
| Composition K | 2.908 |
| Composition H | 3.003 |
| VESTANAT B 1358A | 8.098 |
| Tin catalyst | 0.101 |
| NMP | 0.333 |

### EXAMPLE 7

The procedure of Example 1 was used with the following materials:

| Material | Weight (grams) |
|---|---|
| Composition L | 7.345 |
| Composition K | 2.684 |
| PC-1122⁽¹²⁾ | 3.513 |
| VESTANAT B 1358A | 8.098 |
| Tin catalyst | 0.105 |
| NMP | 0.546 |

⁽¹²⁾An aliphatic polycarbonate diol, reported to be polyhexamethylene dicarbonate, available from Stahl USA.

### EXAMPLE 8

The procedure of Example 1 was used with the following materials:

| Material | Weight (grams) |
|---|---|
| Composition L | 7.113 |
| Composition K | 2.684 |
| Composition G | 3.181 |
| VESTANAT B 1358A | 8.098 |
| Tin catalyst | 0.102 |
| NMP | 0.409 |

### EXAMPLE 9

The procedure of Example 1 was used with the following materials:

| Material | Weight (grams) |
|---|---|
| Composition L | 3.618 |
| Composition K | 1.566 |
| Composition D | 1.368 |
| VESTANAT B 1358A | 4.049 |
| Tin catalyst | 0.050 |

### EXAMPLE 10

The procedure of Example 1 was used with the following materials:

| Material | Weight (grams) |
|---|---|
| Composition L | 3.996 |
| Composition K | 0.783 |
| Composition E | 2.046 |
| VESTANAT B 1358A | 4.049 |
| Tin catalyst | 0.051 |

### EXAMPLE 11

The procedure of Example 1 was used with the following materials:

| Material | Weight (grams) |
|---|---|
| Composition L | 3.824 |
| Composition K | 0.671 |
| Composition F | 1.940 |
| VESTANAT B 1358A | 4,049 |
| Tin catalyst | 0.050 |

### EXAMPLE 12

The procedure of Example 1 was used with the following materials:

| Material | Weight (grams) |
|---|---|
| Composition L | 4.940 |
| Composition K | 2.305 |
| Composition J | 2.711 |
| VESTANAT B 1358A | 5.215 |
| Tin catalyst | 0.071 |

### EXAMPLE 13

The procedure of Example 1 was used with the following materials:

| Material | Weight (grams) |
|---|---|
| Composition L | 4.940 |
| Composition K | 2.612 |
| Composition J | 2.168 |
| VESTANAT B 1358A | 5.562 |
| Tin catalyst | 0.071 |

### EXAMPLE 14

The procedure of Example 1 was used with the following materials:

| Material | Weight (grams) |
|---|---|
| Composition L | 4.940 |
| Composition K | 2.962 |
| Composition J | 1.548 |
| VESTANAT B 1358A | 5.958 |
| Tin catalyst | 0.071 |

### COMPARATIVE EXAMPLE 1

The procedure of Example 1 was used to produce a photochromic polyurethane composition of the type described in WO 98/37115, with the following materials:

| Material | Weight (grams) |
|---|---|
| Composition L | 5.290 |
| Composition K | 2.463 |
| QO POLYMEG 1000 diol⁽¹³⁾ | 2.172 |
| VESTANAT B 1358A | 8.098 |
| Tin catalyst | 0.089 |

⁽¹³⁾Poly(oxytetramethylene)diol having a number average molecular weight of 1000 which is available from Great Lakes Chemical Corporation.

### EXAMPLE 15

### Part A

The solutions prepared in Examples 1-14 and Comparative Example 1 (CE1) were applied via a spincoating method to thermoplastic polycarbonate lenses that were previously coated with a non-tintable hardcoat by the supplier. The lenses were 70 millimeters in diameter and were obtained from Gentex Optics, Inc.; Orcolite, a division of Benson Eyecare Corp.; Vision-Ease, a unit of BMC Industries, Inc.; and/or SOLA Optical USA. Prior to the application of the coating, each lens was washed with detergent and water, rinsed with water followed by a rinse with deionized water, sprayed with isopropyl alcohol and dried in a warm convection oven and treated with oxygen plasma. The lenses were treated with plasma in a PLASMAtech/PLASMAfinish microwave gas plasma system (unit) under the following conditions: power was set to 100 Watts; gas pressure was 38 pascals; a gas flowrate of 100 mL/minute was used; and the processing time was 60 seconds.

Approximately 800 milligrams of solution was dispensed onto each lens that was spinning at 2000 rpm, which resulted in a wet film weight of approximately 200 milligrams per lens. The coated lenses were cured for 75 minutes in a convection oven maintained at 140° C. The final thickness of the dried coatings was approximately 20 microns.

### Part B

The photochromic coated test lenses prepared in Part A were subjected to microhardness (Fₕ) testing using a Fischerscope HCV, Model H-100 available from Fischer Technology, Inc. The microhardness, measured in Newtons (N) per mm², of the coated test samples was determined by taking 3 measurements at a depth of 2 microns in the center area of the test sample prepared for each Example under the conditions of a 100 milliNewton load, 30 load steps and 0.5 second pauses between load steps. Prior to testing, each lens was stored in an enclosed chamber having a humidity of about 50 percent and a temperature of about 23° C. for at least 12 hours. The test results are listed in Table 1.

### Part C

The photochromic coated test lenses from Part B were placed in a PLASMAtech/PLASMAfinish microwave gas plasma system. The lenses were treated with oxygen plasma under the following conditions: power was set to 100 Watts; gas pressure was 38 pascals; a gas flowrate of 100 mL/minute was used; and the processing time was 60 seconds.

The plasma treated lenses were coated with Hi-Gard® 1030 coating solution (available from PPG Industries, Inc.) via a spincoating method. Approximately 4 mL of Hi-Gard® 1030 coating solution was dispensed onto each lens, which was spinning at 1100 revolutions per minute (rpm) for 13 seconds. Afterwards, the lenses were heated in a 60° C. oven for 20 minutes and then in a 120° C. oven for 3 hours. The final thickness of the dried coatings was approximately 2 microns.

### Part D

The percent swelling of the photochromic polyurethane resin films prepared from the solutions of Examples 1-14 and CE 1 was determined in the Percent Swelling Test by the following procedure. About 0.5 milliliters (mL) of solution was applied to a glass microscope slide covered with a Tedlar® film available from E.I. duPont de Nemours and Company. A drawdown of the sample on the glass slide was done with a number 20 bar available from the Paul N. Gardner Co. The coated slide was cured at 140° C. for 75 minutes. Afterwards, the cured film was removed from the Tedlar® film by applying adhesive tape to the cured film and carefully separating the two. A sample of the cured film having an outside diameter of 0.023 inches (0.058 centimeters) was collected with a 20 gauge hypodermic needle modified, i.e., with the point removed, to collect such samples. The sample was placed in a microscope slide having a well. The sample was examined using an optical microscope connected to a computer having access to the Internet. Using a magnification of 41 times, an image of the sample was captured using VCA 2500 version 1.14 software available from AST Products, Inc. The following Internet address was accessed—http://rsb.info.nih.gov/ij/applet/ to utilize the Image J version 1.12 software. Any image area analysis software could be used to generate comparative results, e.g., IGOR from Wavemetrics Inc. The captured image of the cured film sample was opened and the Free Style Drawing option was selected. The outline of the cured film sample was traced and the Analyze, Measure option was selected. The area of the cured film sample was then displayed.

In order to determine how much the sample would swell, about 0.5 mL of isopropyl alcohol (IPA) was added to the microscope well. The sample was monitored for swelling using the above procedure after 3, 5 and 10 minutes or until a constant value was obtained. 5 samples from each cured film were analyzed in this manner. If the standard deviation of the results exceeded 3.0, the test was repeated. The percent swell was determined by dividing the difference between the areas measured before and after the addition of IPA by the area measured before the IPA addition and multiplying by 100. Results are listed in Table 2.

### Part E

The photochromic coated lenses prepared in Part C were screened for ultraviolet absorbance and lenses having comparable UV absorbance at 390 nanometers were tested for photochromic response on an optical bench. Prior to testing on the optical bench, the photochromic lenses were exposed to 365 nanometer ultraviolet light for about 20 minutes to activate the photochromic compounds and then placed in a 75° C. oven for about 20 minutes to bleach (inactivate) the photochromic compounds. The coated lenses were then cooled to room temperature, exposed to fluorescent room lighting for at least 3 hours and then kept covered for at least 1 hour prior to testing on an optical bench. The bench was fitted with a 300 watt Xenon arc lamp, a remote controlled shutter, a Schott 3 mm KG-2 band-pass filter, which removes short wavelength radiation, neutral density filter(s), a quartz plated water cell/sample holder for maintaining sample temperature in which the lens to be tested was inserted.

The power output of the optical bench, i.e., the dosage of light that the sample lens would be exposed to, was adjusted to 1.4 milliwatts per square centimeter (mW/cm²). Measurement of the power output was made using a GRASEBY Optronics Model S-371 portable photometer (Serial #21536) with a UV-A detector (Serial # 22411) or comparable equipment. The UV-A detector was placed into the sample holder and the light output was measured. Adjustments to the power output were made by increasing or decreasing the lamp wattage or by adding or removing neutral density filters in the light path.

A monitoring, collimated beam of light from a tungsten lamp was passed through the sample at 30° normal to the surface of the lens. After passing through the lens, the light from the tungsten lamp was directed through a photopic filter attached to a detector. The output signals from the detector were processed by a radiometer. The control of the test conditions and acquisition of data was handled by the Labtech Notebook Pro software and the recommended I/O board.

Change in optical density (ΔOD) from the bleached state to the darkened state was determined by establishing the initial transmittance, opening the shutter from the Xenon lamp to provide ultraviolet radiation to change the test lens from the bleached state to an activated (i.e., darkened) state at selected intervals of time, measuring the transmittance in the activated state, and calculating the change in optical density according to the formula: ΔOD=log(% Tb/% Ta), where % Tb is the percent transmittance in the bleached state, % Ta is the percent transmittance in the activated state and the logarithm is to the base 10.

The ΔOD was measured after the first thirty (30) seconds of UV exposure and then after eight (8) minutes in the 85° F. (29° C.) Photochromic Performance Test. The Bleach Rate (T ½) is the time interval in seconds for the ΔOD of the activated form of the photochromic compound in the coated lenses to reach one half the eight minute ΔOD at 85° F. (29° C.) after removal of the source of activating light. Results for the photochromic coated lenses tested are listed in Table 3.

TABLE 1

| Example | Microhardness |
|---|---|
| Number | Newtons per mm² |
| 1 | 132 |
| 2 | 149 |
| 3 | 132 |
| 4 | 138 |
| 5 | 102 |
| 6 | 147 |
| 7 | 126 |
| 8 | 131 |
| 9 | 118 |
| 10 | 92 |
| 11 | 101 |
| 12 | 64 |
| 13 | 117 |
| 14 | 135 |
| CE1 | 123 |

TABLE 2

| Example | Percentage of |
|---|---|
| Number | Swelling |
| 1 | 15 |
| 2 | 12 |
| 3 | 14 |
| 4 | 18 |
| 5 | 14 |
| 6 | 16 |
| 7 | 17 |
| 8 | 14 |
| 9 | 15 |
| 10 | 9 |
| 11 | 10 |
| 12 | 13 |
| 13 | 9 |
| 14 | 6 |
| CE1 | 25 |

TABLE 3

| | ΔOD @ 85° F. | ΔOD @ 85° F. | T ½ |
|---|---|---|---|
| Example No. | After 30 sec. | After 8 min. | seconds |
| 1 | 0.20 | 0.34 | 43 |
| 2 | 0.21 | 0.35 | 44 |
| 3 | 0.18 | 0.35 | 61 |
| 4 | 0.21 | 0.34 | 38 |
| 5 | 0.22 | 0.36 | 43 |
| 6 | 0.18 | 0.33 | 52 |
| 7 | 0.21 | 0.35 | 40 |
| 8 | 0.20 | 0.34 | 45 |
| 9 | 0.21 | 0.35 | 40 |
| 10 | 0.22 | 0.38 | 46 |
| 11 | 0.20 | 0.37 | 49 |
| 12 | 0.23 | 0.33 | 30 |
| 13 | 0.18 | 0.31 | 45 |
| 14 | 0.15 | 0.28 | 64 |
| CE1 | 0.23 | 0.36 | 42 |

The results of Tables 1, 2 and 3 show that the lenses coated with the solutions of Examples 1 through 14 had the following properties: microhardness results that were within the desired range from 50 to 150 Newtons/mm²; a ΔOD of at least 0.15 after 30 seconds and at least 0.28 after 8 minutes a fade rate of not more than 70 seconds, all tested at 85° F. (29° C.); and a percent swell of less than 25% in the Percent Swelling Test. The lenses coated with the solution of Comparative Example 1, representing the coatings of WO 98/37115, had a percent swell of 25%, which is outside of the desired range.

We claim:

1. An article comprising, in combination, a substrate, and a photochromic polyurethane coating on at least one surface of said substrate, said coating having a Fischer microhardness of from 50 to 150 Newtons per mm², wherein the improvement comprises preparing said photochromic polyurethane coating from components comprising:
(a) polycarbonate polyol(s) having a molecular weight of from 500 to 5,000 grams per mole;
(b) optionally, a different organic polyol having a molecular weight of at least 500 grams per mole;
(c) an isocyanate;
(d) photochromic compound(s); and
(e) optional catalyst;
said components being used in such proportions to produce a photochromic polyurethane coating exhibiting less than 25% swell in the Percent Swelling Test.

2. The article of claim 1 further comprising a protective hardcoat applied to the photochromic polyurethane coating.

3. The article of claim 2 wherein the protective hardcoat is an organosilane hardcoat.

4. The article of claim 1 wherein said photochromic polyurethane coating exhibits a ΔOD of at least 0.15 after 30 seconds and at least 0.28 after 8 minutes, and a Bleach Rate of less than 70 seconds—all as measured in the 85° F. Photochromic Performance Test.

5. The article of claim 4 wherein the photochromic polyurethane coating exhibits 10% or less swell in the Percent Swelling Test.

6. The article of claim 1 wherein the polycarbonate polyol is represented by
(a) the following general formula I: 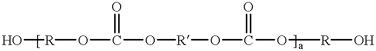
(b) the following general formula II: 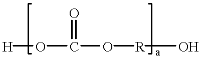
(c) a combination of polycarbonate polyols represented by general formulae I and II wherein each R and R′ independently represent divalent C₂-C₁₀ aliphatic radicals or divalent C₆-C₁₅ aromatic radicals and a is an integer selected from 3 to 15.

7. The article of claim 6 wherein the polycarbonate polyol represented by general formula I is formed by the reaction of a bis(chloroformate) and an organic polyol.

8. The article of claim 7 wherein the bis(chloroformate) is selected from monoethylene glycol bis(chloroformate), diethylene glycol bis(chloroformate), butanediol bis(chloroformate), hexanediol bis(chloroformate), neopentyldiol bis(chloroformate) bisphenol A bis(chloroformate) or mixtures of such bischloroformates.

9. The article of claim 7 wherein the organic polyol is selected from bisphenol A, trimethylolpropane, 1,3-propanediol, 1,4-butanediol, 1,5-pentanediol, 1,6-hexanediol, 1,7-heptanediol, 1,8 octanediol, 1,9-nonanediol; 1,10-decanediol; polyethylene glycol, polypropylene glycol, poly(oxytetramethylene)diol, polycaprolactone polyol or mixtures of such polyols.

10. The article of claim 1 wherein the different organic polyol (b) is selected from polyester polyols; polyether polyols, amide-containing polyols; polyacrylic polyols; epoxy polyols; polyhydric polyvinyl alcohols; urethane polyols and mixtures thereof.

11. The article of claim 10 wherein said polyacrylic polyol is a copolymer of hydroxy-functional ethylenically unsaturated monomers and other ethylenically unsaturated monomers selected from the group consisting of vinyl aromatic monomers, vinyl aliphatic monomers, alkyl esters of (meth)acrylic acids, epoxy-functional monomers, carboxy-functional monomers and mixtures of such ethylenically unsaturated monomers.

12. The article of claim 1 wherein said isocyanate component is a blocked or modified isocyanate.

13. The article of claim 12 wherein said isocyanate component is selected from the group consisting of aliphatic isocyanates, aromatic isocyanates, cycloaliphatic isocyanates, heterocyclic isocyanates and mixtures thereof.

14. The article of claim 13 wherein said isocyanate component is selected from the group consisting of hexamethylene-1,6-diisocyante, isophorone diisocyanate, ethylene diisocyanate, dodecane-1,12-diisocyanate, cyclohexane-1,3-diisocyanate and mixtures thereof.

15. The article of claim 14 wherein said isocyanate component is a blocked isocyanurate of isophorone diisocyanate.

16. The article of claim 15 wherein said blocked isocyanurate is blocked with a blocking compound selected from the group consisting of methanol, diisopropyl amine, 1,2,4-triazole, methyl ethyl ketoxime and mixtures thereof.

17. The article of claim 1 wherein said photochromic compound is selected from the group consisting of naphthopyrans, benzopyrans, phenanthropyrans, indenonaphthopyrans, spiro(benzindoline)naphthopyrans, spiro(indoline)benzopyrans, spiro(indoline)naphthopyrans, spiro(indoline)quinopyrans, spiro(indoline)pyrans, spiro(indoline)naphthoxazines, spiro(indoline)pyridobenzoxazines, spiro(benzindoline)pyridobenzoxazines, spiro(benzindoline)naphthoxazines, spiro(indoline)benzoxazines, mercury dithizonates, fulgides, fulgimides and mixtures of such photochromic compounds.

18. The article of claim 1 wherein the catalyst is selected from 1,4-diazabicyclo[2.2.2]octane, dibutyl tin acetate, dibutyl tin dilaurate or mixtures thereof.

19. The article of claim 1 wherein a primer layer is interposed between the substrate and the photochromic polyurethane coating.

20. The article of claim 1 wherein said substrate is selected from the group consisting of paper, glass, ceramic, wood, masonry, textile, metal and organic polymeric materials.

21. The article of claim 20 wherein said organic polymeric material is selected from the group consisting of poly(C₁-C₁₂ alkyl methacrylates), poly(oxyalkylene dimethacrylates), poly(alkoxylated phenol methacrylates), cellulose acetate, cellulose triacetate, cellulose acetate propionate, cellulose acetate butyrate, poly(vinyl acetate), poly(vinyl alcohol), poly(vinyl chloride), poly(vinylidene chloride), thermoplastic polycarbonates, polyesters, polyurethanes, polythiourethanes, poly(ethylene terephthalate), polystyrene, poly(alpha methylstyrene), copoly(styrene-methylmethacrylate), copoly(styrene-acrylonitrile), polyvinylbutyral and polymers of bis(allyl carbonate) monomers, polyfunctional acrylate monomers, polyfunctional methacrylate monomers, diethylene glycol dimethacrylate monomers, diisopropenyl benzene monomers, ethoxylated bisphenol A dimethacrylate monomers, ethylene glycol bismethacrylate monomers, poly(ethylene glycol) bismethacrylate monomers, ethoxylated phenol bis methacrylate monomers, alkoxylated polyhydric alcohol polyacrylate monomers, styrene monomers, urethane acrylate monomers, glycidyl acrylate monomers, glycidyl methacrylate monomers, and diallylidene pentaerythritol monomers.

22. The article of claim 21 wherein the organic polymeric material is a solid transparent polymer selected from the group consisting of poly(methyl methacrylate), poly(ethylene glycol bismethacrylate), poly(ethoxylated bisphenol A dimethacrylate), thermoplastic polycarbonate, poly(vinyl acetate), polyvinylbutyral, polyurethane, polythiourethane and polymers of diethylene glycol bis(allyl carbonate) monomers, diethylene glycol dimethacrylate monomers, ethoxylated phenol bis methacrylate monomers, diisopropenyl benzene monomers and ethoxylated trimethylol propane triacrylate monomers.

23. The article of claim 22 wherein said substrate is an optical element.

24. The article of claim 23 wherein said optical element is a lens.

25. The article of claim 24 wherein the refractive index of said lens is from 1.48 to 1.75.
